(19) United States
(12) Patent Application Publication
(10) Pub. No.: US 2025/0267019 A1
(43) Pub. Date: Aug. 21, 2025

(54) BLOCKCHAIN TRANSACTION

(71) Applicant: nChain Licensing AG, Zug (CH)

(72) Inventor: Enrique LARRAIA, London (GB)

(21) Appl. No.: 18/859,322

(22) PCT Filed: Apr. 24, 2023
(86) PCT No.: PCT/EP2023/060628

§ 371 Date: Oct. 23, 2024

(30) Foreign Application Priority Data
Apr. 26, 2022 (GB) 2206040.4

(51) Int. Cl. H04L 9/00; H04L 9/32

(52) U.S. Cl. CPC H04L 9/50; H04L 9/3218; H04L 9/3271

(57) ABSTRACT

A computer-implemented method for generating a blockchain transaction is provided. A first locking script of a challenge blockchain transaction comprising a target statement and a verification script for verifying a challenge solution π provided in a first unlocking script of a proof blockchain transaction is generated. The challenge solution π is a non-interactive zero-knowledge proof proving knowledge of a secret witness w. The first locking script, when executed with the first unlocking script, is configured to: compute, based on the challenge solution π and one of the target statement and a candidate statement provided in the first unlocking script, a candidate commitment value A*; compute, using the candidate commitment value A* and one of the target and candidate statements, a candidate hash value; verify, based on the candidate hash value, the challenge solution π; and verify that the challenge solution π is provided in the proof blockchain transaction.

### CROSS REFERENCE TO RELATED APPLICATIONS

This application is the U.S. National Stage of International Application No. PCT/EP2023/060628 filed on Apr. 24, 2023, which claims the benefit of United Kingdom Patent Application No. 2206040.4, filed on Apr. 26, 2022, the contents of which are incorporated herein by reference in their entireties.

### TECHNICAL FIELD

The present disclosure relates to a computer implemented method for generating a blockchain transaction with an output locked based on a challenge and a computer-implemented method for generating a blockchain transaction comprising an unlocking script for providing a challenge solution for unlocking the locking script.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicized. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

Most locking scripts are of one of a limited number of types, including pay-to-public key (P2PK), pay-to-public key hash (P2PKH), and multi-signature. Whilst these are suitable for many applications, it would be desirable to extend the functionality of the blockchain by providing additional mechanisms for locking unspent transactions outputs (UTXOs). In addition, most locking scripts typically work on the premise of enforcing the spender of the UTXO to provide certain data in the unlocking script of the spending transaction. This can create security and/or privacy problems in some circumstances. Therefore, it would be beneficial to be able to lock a UTXO based on (secret) data, without having to reveal that data in the unlocking script.

According to one aspect disclosed herein, there is provided a computer-implemented method for generating a blockchain transaction, the method comprising: generating a first locking script of a challenge blockchain transaction comprising a target statement and a verification script for verifying a challenge solution π provided in a first unlocking script of a proof blockchain transaction, wherein the challenge solution π is a non-interactive zero-knowledge proof proving knowledge of a secret witness w, wherein the first locking script, when executed with the first unlocking script, is configured to: compute, based on the challenge solution π provided in the first locking script and one of the target statement and a candidate statement provided in the first unlocking script, a candidate commitment value A*; compute, using the candidate commitment value A* and one of the target statement and the candidate statement, a candidate hash value; verify, based on the candidate hash value, the challenge solution π; and verify that the challenge solution π is provided in the proof blockchain transaction; and causing the blockchain transaction to be made available to one or more nodes of a blockchain.

Unlike standard puzzles, a solution to a zero-knowledge puzzle is never posted on-chain in an unlocking script (also referred to herein as a “scriptSig field”) of a spending transaction. Instead, the scriptSig field contains a mathematical proof that ascertains knowledge of the solution. The proof itself reveals no information about the solution. The verification of the mathematical proof is implemented in Script and embedded in the locking script (also referred to herein as a “script PubKey field”) of the transaction that is being spent.

More specifically, let a mathematical finite group [symbol] of p elements. The unlocking script of the spending transaction contains a non-interactive zero-knowledge (nizk) proof π that proves knowledge of a secret witness w∈ [symbol] —the undisclosed puzzle solution. The locking script of the transaction being spent implements the verification algorithm that checks the correctness of π with respect to a public statement P∈ [symbol] that is also embedded in the locking script.

As described in the Detailed Description, embodiments of the present disclosure provide for locking scripts that offer one or more of increased security, privacy, compatibility and flexibility over at least some existing locking scripts.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of some node software for processing transactions,

FIG. 4a shows a sigma protocol for proving knowledge of preimages under φ,

FIG. 4b shows an interactive sigma protocol for an OR relation,

FIG. 5 schematically illustrates the use of a zero-knowledge puzzle to pay to a generic ECDSA public key,

FIG. 6 schematically illustrates the use of a zero-knowledge puzzle to pay to a group privately,

FIG. 7 schematically illustrates the use of a zero-knowledge puzzle to pay to a threshold group privately,

FIG. 8 schematically illustrates a method for two collaborators to generate a challenge proof for the zero-knowledge puzzle, and

FIG. 9 schematically illustrates a method for three collaborators to generate a challenge proof for the zero-knowledge puzzle.

### DETAILED DESCRIPTION OF EMBODIMENTS

### 1. Example System Overview

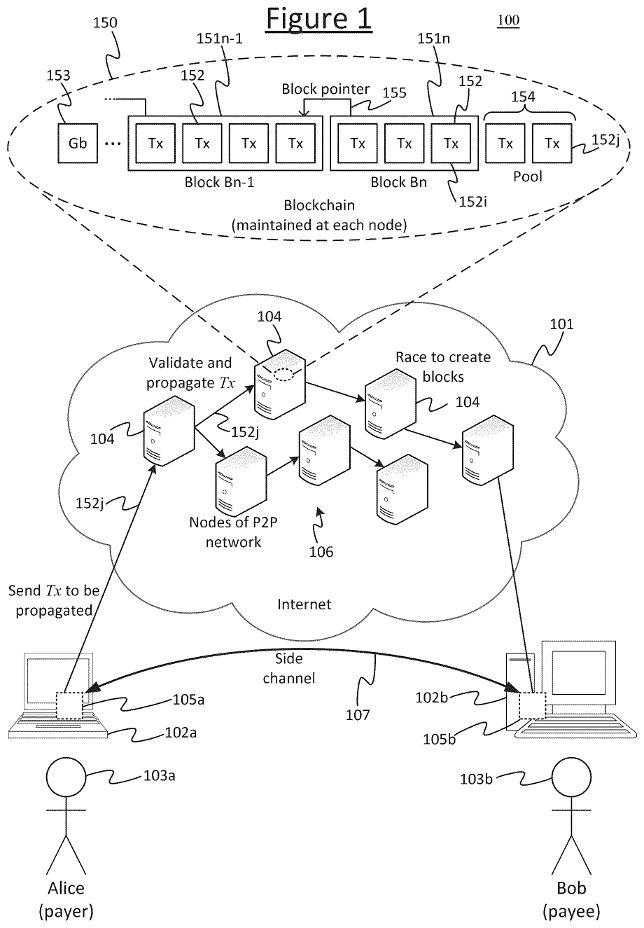

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorize (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

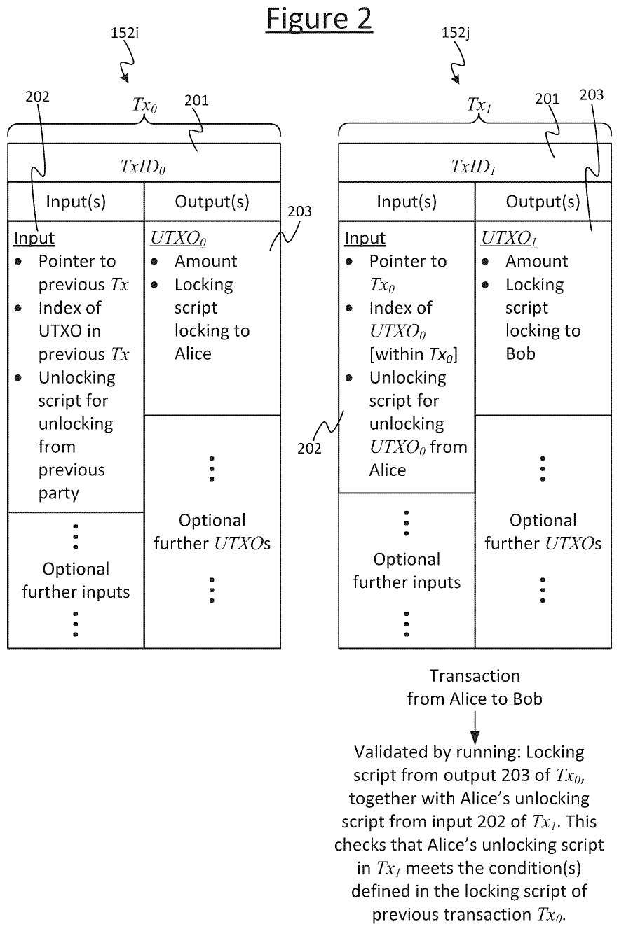

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} > \vert \vert [ Check sig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Node Software

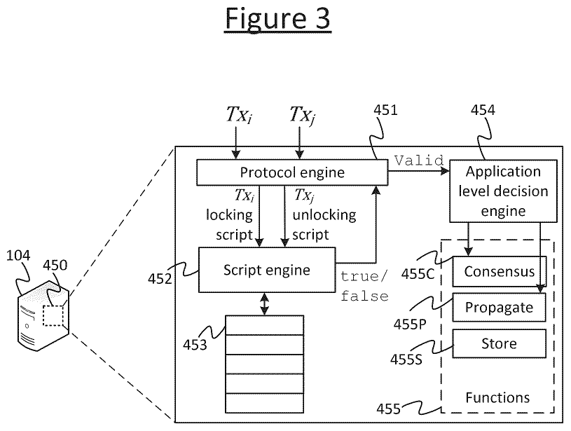

FIG. 3 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Tx and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Tx₁ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 5. Zero-Knowledge Proof

Let [symbol] be a finite group of order p, and let [symbol] be the ring of exponents. Elements in [symbol] are denoted with small roman letters x∈ [symbol] , and elements in [symbol] with capital roman letters G∈ [symbol] . Vectors of n elements in [symbol] are denoted as \tilde{x}. Likewise, vectors of m elements in [symbol] are denoted as \tilde{G}. The symbol + is used for both the group operation of [symbol] (in additive notation) and for the addition in the ring [symbol] (mod p addition).

p is not required to be a prime number. However, for practical instantiations, p is a prime. Typically, [symbol] is set to be an elliptic curve of prime order.

### 5.1 Sigma Protocol

Let [symbol] be an NP-relation. That is, a subset of {0,1}*×{0,1}* such that (st,w)∈ [symbol] can be checked in polynomial time in the length of st, and the length of w is also polynomial in the length of st.

The first element of the tuple is called the statement and it is public information. The second element is called the witness (to the statement) and it is private. There might be more than one witness for a given statement. The induced NP-language [symbol] is the set of statements.

[symbol]

:={st:∃w such that (st,w)∈ [symbol] }.

Camenisch-Stadler notation is used herein to denote the set of witnesses (the knowledge set) as:

ZKPoK(st):={w:(st,w)∈ [symbol] }.

This notation is used herein as is it convenient to compactly differentiate between the statement st, the witness w, and the predicate [symbol] acting on them.

A sigma protocol is a three-round protocol between a prover and a verifier with the following structure. Both parties receive as input the statement st. Additionally, the prover receives the witness w as an extra input.
1. The prover computes a commitment A using randomness a. It then sends A to the verifier while it keeps a secret.
2. The verifier randomly samples a challenge e and sends it to the prover
3. The prover computes an answer z (using w and a) and sends it to the verifier.
4. The verifier based on the public transcript π:=(A,e,z) accepts the statement st as valid or not.

The properties of a sigma protocol are:

Completeness. If (st,w)∈ [symbol] then the verifier accepts with probability one.

Special soundness. For any pair of accepting transcripts π=(A,e,z),π′=(A,e′,z′) that have the same commitment A (first message of the prover) and distinct challenges e+e′, it is possible to compute a witness w, such that (st,w)∈ [symbol] .

Special honest verifier zero-knowledge (SHVZK). There exists a polynomial-time algorithm Sim which on input st∈ [symbol] and random e, it outputs accepting transcripts π=(A,e,z) indistinguishable from protocol's transcripts.

Special soundness implies a stronger property: sigma protocols are also proof of knowledge (of a witness).

Also, SHVZK implies the standard notion of (honest-verifier) zero-knowledge, where the simulator is tasked with simulating transcripts on receiving only the statement as input. In other words, SHVZK guarantees that no information about the witness is leaked from the exchanged messages assuming the verifier behaves as prescribed.

### 5.2 Relations Based on Group Homomorphisms

NP-statements about elements of groups of prime order are considered herein, which includes elliptic curves. Let a prime p, a group [symbol] of order p, and a one-way homomorphism φ: [symbol] → [symbol] . Defining the binary relation as [symbol] :={(\tilde{Y},\tilde{x}):Y̅=φ(x̅)} gives knowledge set:

$$ZKPoK ( \overline{Y} ) := \{ \overline{x} ∈ {ℤ}_{p}^{n} : \overline{Y} = φ ( \overline{x} ) \} .$$

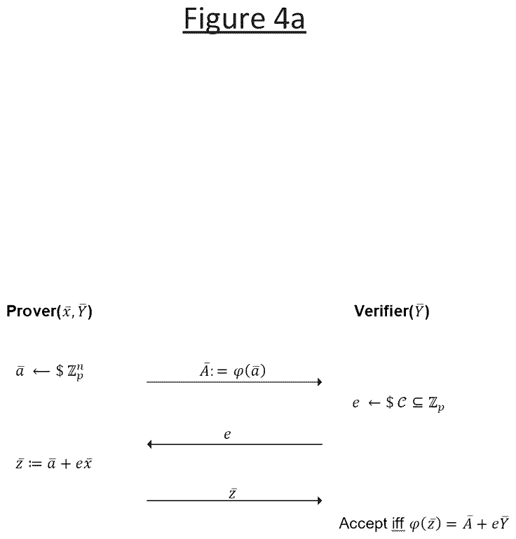

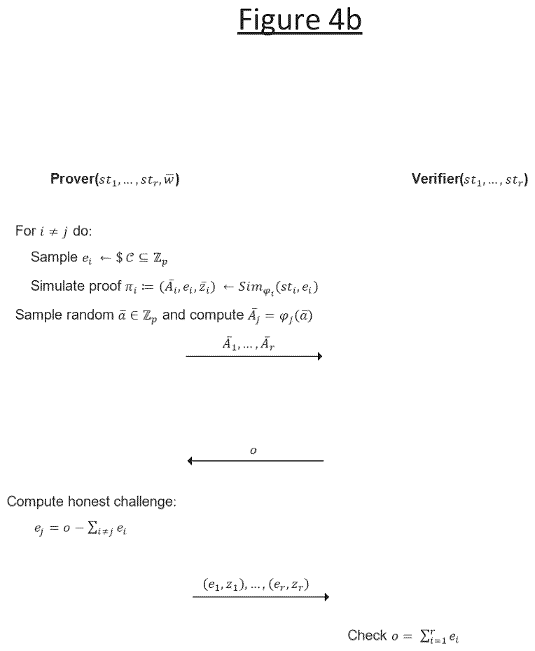

The protocol set out in FIG. 4a has been shown to be sound and SHVZK. For a given vector Y̅ of group elements, it proves knowledge of a preimage x̅under φ.

### 5.3 Simulating Transcripts

The simulator algorithm Sim_{φ} for zero knowledge on input point Y̅ (derived from the statement) and challenge e does the following:
1. Sample random z∈ [symbol]
2. Compute Ā=φ(z̅)−eY̅
3. Output simulated proof π=(Ā,e,z̅)

The simulated proof is perfectly valid to the Verifier because it will pass the test equation. In fact, it is identically distributed to an honest proof if e is random. Note this special way of simulation is only possible if the challenge e is known when generating the first message Ā, and therefore a cheating Prover engaging in the interactive protocol described in FIG. 4a will not be able to do it.

Proof simulation is not only useful to argue that no information about the witness is leaked (since it is possible to generate transcripts as in the protocol without using the witness). The algorithm is also used to prove OR statements, as set out in section 5.5.

### 5.4 Conjunctive Proofs

AND proofs prove knowledge of n independent witnesses of (possibly different) relations [symbol] , . . . , [symbol] . When restricted to the relations [symbol] as explained above in section 5.1, the knowledge set for the AND relation is then:

$$ZKPoK ( {st}_{1} , … , {st}_{s} ) : = \{ ( {w}_{1} , … , {w}_{s} ) : ( {st}_{1} , {w}_{1} ) ∈ {ℛ}_{{φ}_{1}} ∧ … ∧ ( {st}_{s} , {w}_{s} ) ∈ {ℛ}_{{φ}_{s}} \} .$$

[symbol] can be seen as a yet another preimage knowledge relation where φ_{AND} is the compound group homomorphism:

$${φ}_{AND} : {ℤ}_{p}^{{n}_{1}} \times … \times {ℤ}_{p}^{{n}_{x}} \to {𝔾}^{{m}_{1}} \times … \times {G}^{{m}_{s}} , {φ}_{AND} ( {\overline{x}}_{1} , … , {\overline{x}}_{1} ) := ( {φ}_{1} ( {\overline{x}}_{1} ) , … , {φ}_{s} ( {\overline{x}}_{s} ) )$$

The Σ_{AND}-protocol simply runs the protocol of FIG. 4a for φ_{AND}. Note that the same challenge is used to prove preimage knowledge of all φᵢ(x̅ᵢ).

### 5.5 Disjunctive Proofs

In this scenario, the aim is to verify knowledge of a witness for at least one statement out of r. The knowledge set of the OR relation is:

$$ZKPoK ( {st}_{1} , … , {st}_{r} ) : = \{ w : {st}_{1} , w ) ∈ {ℛ}_{{φ}_{1}} ∨ … ∨ ( {st}_{r} , w ) ∈ {ℛ}_{{φ}_{r}} \}$$

The idea of an OR-proof is to let the prover simulate all but the one of the proofs, that is the prover can simulate proofs for the statements they do not know a witness for, but without giving them too much freedom in choosing the challenges (they can select exactly r−1 challenges). This way, they are forced to prove knowledge of a witness for at least one relation.

In more detail, let stⱼ be the real statement—that is the prover knows w such that (stⱼ, w)∈ [symbol] . Proof πᵢ for i≠j is generated with the simulator Sim_{φi} of the sigma protocol Σ_{φi} (see section 5.3), selecting the challenges eᵢ in advance. However, the challenge for the j-th proof is completely determined by the other challenges and an offset value, also referred to herein as the offset challenge, given by the verifier after they see all commitments Ā₁, . . . , Āᵣ. This ensures that the Prover generates πⱼ with the knowledge of the witness w.

FIG. 4b shows the interactive version of the Σ_{OR}-protocol.

### 5.6 Removing Interaction—the Fiat-Shamir Heuristic

It is desirable to restrict communication to just one message from the Prover to the Verifier.

Sigma protocols are examples of public-coin interactive proof systems. That is, the message sent by the verifier (the challenge) is random and independent from the Prover's messages. Exploiting this feature, an interactive sigma protocol can be turned non-interactive by emulating verifier's entropy used to sample the challenge e with a cryptographic hash function. This is known as the Fiat-Shamir heuristic.

The Fiat-Shamir heuristic operates in a stronger security model. Therein, a cryptographic hash function is modelled as a function that on fresh input bitstrings it outputs uniformly distributed bitstrings. In this security model, well-known hash functions, like SHA256, can be used to construct a ‘random oracle’ function RO:{0,1}*→ [symbol] that maps arbitrary bitstrings to challenges in [symbol] ⊆ [symbol] . Now, the prover can compute e without the help of the verifier, by setting e:=RO(st∥Ā). Observe that tr:=st∥Ā is the (public) transcript occurring right after the challenge e is generated by the verifier in the interactive sigma protocol.

The assumption on the RO function ensures two things. First, the challenge e is randomly distributed, and therefore, zero-knowledge against honest verifiers suffices. Second, the prover is unable to calculate the challenge before calculating the commitment Ā (and the statement st for that matter), so the order of execution of the protocol cannot be inverted. The latest is true provided the challenge space is large enough so that trying with different commitments Ā does not ever hit the (unique) challenge that would allow simulation. Namely trying out until

$$RO ( st , ‖ \overline{A} ) = {e}^{*} := \frac{φ ( z )}{Y} .$$

(See Section 5.3) The probability of hitting e* is

$$\frac{1}{\vert 𝒞 \vert} .$$

### 5.6.1 Binding Information to the Non-Interactive Proof

Any public context information ctxt can be bound to the proof by prepending the context information to the input of the random oracle RO. This means that the challenge e also depends on ctxt and therefore such information is guaranteed to be originated by the Prover (because only him can prove knowledge of the witness). Specifically, the challenge e of the non-interactive sigma proof is generated as:

$$e := Hash ( ctxt ‖ st ‖ \overline{A} ) .$$

### 5.6.2 Shorter Proofs

To reduce the size of the puzzle solution-concretely, the size of the Σ-proof π-, an equivalent verification procedure can be used that allows the commitment Ā to be removed from the transmitted proof. With this verification, the proof is defined as π:=(e,z̅).

Verify(ctxt,st,π):
On input context information ctxt, image points Y̅ (derived from the statement st) and
proof π = (e,z̅):

| | |
|---|---|
| 1. | Recompute the commitment Ā = φ(z̅) − eY̅ |
| 2. | Check that e = RandomOracle(ctxt,st\|\|Ā). Accept if this is the case. Else, reject the |
| | proof |

### 6. Specification of Zero-Knowledge Puzzles

A zero-knowledge puzzle is an NP-language [symbol] (see Section 5.1) resulting from AND/OR combinations of other NP-languages [symbol] supporting Script verification. Such a language [symbol] (again, with Script verification) is referred to as a piece of the puzzle. A solution to the puzzle is a statement st∈ [symbol] along with a non-interactive zero-knowledge argument π (nizk) attesting for its veracity. The non-interactive zero-knowledge argument π may also be referred to herein as a proof or challenge solution.

Roadmap to specify zero-knowledge puzzles: The specification of zero-knowledge puzzles consists in defining Script algorithms for the different verifiers from Section 5. These are centralized through the generic non-interactive verifier described in section 5.6.2.

Specifying a script for this generic verifier means we need to be able to apply the group homomorphism φ to the answer z̅, and instantiate the random oracle.

Section 6.1 below describes the abstract structure (template) of zero-knowledge puzzles scripts. Section 6.2 provides a concrete instantiation of the random oracle function RO in Script (see Section 5.6). The remaining sections deal with the implementation of the (non-interactive version of the) verifiers on-chain: Section 6.3 implements the preimage-knowledge verifier from 4a, Section 6.4 the conjunctive (AND) verifier, and Section 6.5 the disjunctive (OR) verifier.

### 6.1 Structure of Zero-Knowledge Puzzles as Spending Conditions

The steps necessary to construct a zero-knowledge puzzle as a locking script, and its solution as the corresponding unlocking script, are described below.

### 6.1.1 Binding the Spending Transaction to the Nizk Proof

The integrity of the spending transaction (the transaction that provides the puzzle solution in the unlocking script) against a corrupted miner or a man-in-the-middle attacker, it is enforced at the script engine 452 level.

The integrity of the transaction is verified using a dummy signature technique. A digital signature tx_dummy_sign:=(r,s), generated with signing key and, optionally, the ephemeral key fixed to one, is included in the unlocking script. The dummy signature may be an ECDSA signature. This signature over secp256k1 allows the opcode OP_CHECKSIG to be leveraged to ensure integrity.

It will be appreciated that other forms of ensuring transaction integrity may be used, for example injection techniques such as the so-called OP_PUSHTX technique. The dummy signature technique is used herein because it is more efficient than other known techniques.

Once verified, tx_dummy_sign is used as context information to generate the non-interactive challenge on-chain. (See also Section 6.2)

### 6.1.2 Generating the Locking Script

The locking script may be generated using the following steps:
1. Write out the NP-language of the use case. In its more general form, the language can be expressed in disjunctive normal form:

$$ℒ := {V}_{i = 1}^{r} ( {∧}_{j = 1}^{s} {ℒ}_{φ i , j} ) ,$$

where [symbol] are preimage knowledge languages for arbitrary group homomorphisms φ_{i,j}: [symbol] → [symbol] .
2. Code up the resulting verifier script [ [symbol] -verifier] using the modular framework of the next sections.
3. Let a public statement st∈ [symbol] . Hardcode it in the locking script. (Alternatively, for “puzzles as addresses”, hardcode the hash of the statement).

The locking script generated by following the above steps may be as follows:

$$[ ls ] := \begin{matrix}OP\_DUP < G > OP\_CHECKSIGVERIFY \\ OP\_SWAP OP\_DUP < st > OP\_EQUALVERIFY [ {\sum }_{ℒ} - verifier ]\end{matrix}$$

where G denotes the base point of curve secp256k1, st is a target statement, and [ [symbol] −verifier] is a verification script for verifying the challenge solution π. The verification script provided in the locking script depends on the application, i.e. the type of puzzle being used, as set out in more detail below. The locking script, when executed, checks that a candidate statement provided in the unlocking script matches the target statement of the unlocking script and verifies the challenge solutions provided in the unlocking script.

### 6.1.3 Generating the Unlocking Script

An unlocking script may be generated using a candidate statement st∈ [symbol] and a secret witness w by implementing the following steps:
1. Let tx_dummy_sign be the dummy signature on the SIGHASH serialization of the transaction.
2. Create the nizk proof π.
   To ensure transaction integrity of the transaction fields, use tx_dummy_sign as context information ctxt. This ensures the proof provided in the unlocking script is linked to the fields of the transaction. It will be apricated that other methods may be used to prove transaction integrity.
   If necessary, collaborate to create the nizk proof. This is needed when the witness is split across several parties-see Section 7.3 for an example.
3. Include the context information, the candidate statement, and the nizk proof, also referred to herein as the challenge solution in the unlocking script.

The unlocking script generated by following the above steps may be as follows:

$$[ us ] := < π > < st > < tx\_dummy \_sign >$$

where π is the challenge solution, st is the candidate statement, and tx_dummy_sign is the context information (here the dummy signature).

The challenge solution π is a vector of elements, the length of which depends on the application as described below.

### 6.2 Instigating the Random Oracle

In the examples presented herein, the groups are of order p>2¹²⁸, so it is sufficient to set the challenge space to [symbol] := [symbol] . This choice ensures a conservative security level of 128 bits for the soundness of the sigma protocols. Other orders may be chosen. The random oracle function H is instigated as:

$$RO : {\{ 0 , 1 \}}^{*} \to 𝒞 , RO ( x ) := SHA 256 ( x ) mod {2}^{128} .$$

As defined, RO maps bitstrings x of arbitrary length to uniformly distributed (under the ROM heuristic) values in [symbol] . It is observed that the modular reduction step does not introduce any bias on the outputs of the hash function SHA256. This is because the output byte array d:=SHA256(x) is of size exactly 256 bits and mod 2¹²⁸ is applied (so every point in the image of RO has exactly two preimages equally likely).

An example random oracle script to generate a 128-bit challenge is:

$$< x > [ Random Oracle ( 128 ) ] := OP\_SHA 256 < {2}^{128} > OP\_MOD$$

Another possibility is to generate 160-bit challenges with the following (slightly more efficient) script:

$$< x > [ Random Oracle ( 160 ) ] := OP\_HASH 160$$

The caveat of using 160-bit challenges is that challenges are 4 bytes longer than before. For large OR proofs this might not be desirable. The challenge space is [symbol] := [symbol] and the random oracle is defined as:

$$RO : {\{ 0 , 1 \}}^{*} \to 𝒞 , RO ( x ) := RIPEMD 160 ( SHA 256 ( x ) )$$

The dummy signature tx_dummy_sign of the spending transaction is bound to the proof provided in the unlocking script of the spending transaction by prepending it to the input of RO. That is:

$$c := tx\_dummy \_sign ‖ st ‖ \overline{A}$$

where Ā is the commitment.

The digest d:=SHA256(x) is interpreted as an integer in little endian, which allows RO to be instigated in Script. The Prover must interpret the digest in the same way to ensure consistency (i.e., same challenge is computed by either party). Also note that if the Prover uses little endian, then there is no need to implement reverse endianness in Script.

### 6.3 Verifying Knowledge of Preimages

The verification script [Σ_{φ}-verifier] is described below for a given group homomorphism φ implementing the algorithm set out in section 5.6.2. This script can be considered to be implemented in two steps: first recompute the commitment, then check the challenge.

### Step 1—Recompute Commitment

The first step recomputes the commitment using the target statement st provided in the unlocking script and the challenge solution π:=(e,z̅), wherein e is a target challenge and z̅ is a target challenge answer. The steps of the script [Σ_{φ}-verifier recompute commitment] are as follows:
a. If not explicit, derive image point Y̅ from the target statement st.
b. Extract the challenge e from π and compute eY̅.
c. Extract the answer z̅ from π and compute Z̅:=φ(z̅).
d. Compute the candidate commitment Ā*=Z̅−eY̅

The homomorphisms is instantiated over elliptic curves. Thus, the group [symbol] is an elliptic curve of order p. A Script interface for elliptic curve arithmetic is used. The following notation is used herein:
[Add points]: Adds two points (of an elliptic curve).
[Subtract points]: Subtracts two points.
[Multiply by scalar]: Multiplies a point by a scalar.
[Multiply P by scalar]: Multiplies a hard-coded point P by a scalar.
[Are equal points]: Returns true if and only the two points are equal.
[Negate point]: Returns the inverse of a point.

This Script interface suffices to compute steps (a)-(d) above for any given elliptic curve homomorphism φ: [symbol] → [symbol] . The homomorphism function φ depends on the application.

### Step 2—Check Challenge

The second step checks whether the target challenge e embedded in the proof π has been correctly computed. Let Ā* be the recomputed commitment in step 1, also referred to herein as a candidate commitment value, let tx_dummy_sign be the dummy signature of the spending transaction, and let st be the candidate statement. The script [Σ_{φ}-verifier check challenge] implements the following steps:
a. Concatenate x:=tx_dummy_sign∥st∥Ā* (with opcode OP_CAT)
b. Execute script [Random Oracle] from Section 6.2. This step recomputes the challenge e*, also referred to herein as the candidate challenge, from the public transcript x.
c. Extract the target challenge e from the challenge solution π and check it matches the candidate challenge e* (with OP_EQUAL).

The script pushes 1 to the top of the stack if the recomputed challenge matches the one extracted from the proof. Else, pushes 0.

The candidate challenge e+ may also be referred to herein as a candidate hash value.

### 6.4 Verify “And” Proofs

Conjunctive proofs of s preimage knowledge relations [symbol] are verified exactly in the same way as in the previous section. The only difference is that the hard-coded group homomorphism in script [Σ_{φAND}-verifier] is the compound φ_{AND}(x̅₁, . . . , x̅ₛ):=(φ₁(x̅₁), . . . , φₛ(x̅ₛ)). Refer to Section 5.4 for more details.

### 6.5 Verifying “OR” Proofs

The non-interactive verifier [Σ_{OR}-verifier] is very similar to the verifier from Section 6.3. The main difference is that an offset challenge o is computed based on all commitments Āᵢ:

$$o := RO ( tx\_dummy \_sign ‖ {st}_{1} ‖ … ‖ {st}_{r} ‖ {\overline{A}}_{1}^{*} ‖ … ‖ {\overline{A}}_{r}^{*} )$$

and then enforced against all challenges e; (as described in FIG. 4b).

### Step 1—Recompute Commitment

This is the script [Σ_{OR}-verifier recompute commitment]. r pairs of statement/proofs (st₁,π₁), . . . , (stᵣ,πᵣ), for i=1, . . . , r are input, and the following step implemented:
1. Reconstruct the i-th candidate commitment Ā*ᵢ by running script [Σ_{φi}-verifier recompute commitment] on input the i-th candidate statement stᵢ and the i-th challenge proof πᵢ=(eᵢ,z̅ᵢ)

As explained earlier, elliptic-curve arithmetic is used when implementing this step.

### Step 2—Check Challenge

Let {Ã*ᵢ} be the r recomputed, i.e. candidate, commitments in step 1, let tx_dummy_sign be the dummy signature of the spending transaction, and let st; be the candidate statement. The script [Σ_{OR}-verifier check challenge] consists in the following steps:
a. Concatenate x:=tx_dummy_sign∥st₁∥ . . . ∥stᵣ∥Ā*₁∥ . . . ∥Āᵣ* (with opcode OP_CAT)
b. Execute script [Random Oracle] from Section 6.1 on input x. This step recomputes the offset challenge o* from the public transcript x.
c. Check that o*=Σᵢ₌₁^{r}eᵢ mod 2¹²⁸, where eᵢ are the candidate challenges (with OP_ADD, OP_MOD, and OP_EQUAL).

The script pushes 1 to the top of the stack if the candidate offset challenge o* is consistent with the target challenges e; extracted from the challenge solutions Ti. Else, pushes 0.

### 7. Examples of Zero-Knowledge Puzzles

The modular framework that allows simple puzzles to be composed into arbitrary complex puzzles is set out in the preceding sections. This is achieved using Σ-protocols, a family of public coin zero-knowledge proof systems which are three-round and do not require a trusted setup. Specifically, preimage sigma protocols are described, to prove (in zero-knowledge) preimage knowledge under a group homomorphism φ: [symbol] → [symbol] . For the case [symbol] being an elliptic curve, leveraging on a suitable Script interface for elliptic curve arithmetic, it is shown how the non-interactive verifier of preimage sigma protocols can be implemented as the locking script. Moreover, verify AND/OR statements in Script can be used to achieve modularity.

The versatility of zero-knowledge puzzles is shown by way of three new payment modalities, set out below. In the examples, the spending transaction can be bound to the nizk proof π unequivocally using transaction integrity techniques, or injection techniques. It will be appreciated that further puzzles can be constructed using our Script framework.

The first application set out below is the ability to pay to a generic ECDSA public key P, which is a generalization of the standard P2PK puzzle. Let [symbol] be an elliptic curve with base point G. The requirement to sign over curve secp2561k1 (to which opcode OP_CHECKSIG, is hardcoded) can be dispensed of, and replaced with verification of a nizk proof π_{DL} that proves knowledge of the signing key w—the discrete log of P:=wG∈ [symbol] in base G. The ECDSA signing algorithm can be instantiated over many curves [symbol] , not just secp256k1, as will be appreciated by the skilled person. There are several reasons to customize the curve:
a) Long-lived transactions: Current P2PK UTXOs must be spent within a period no longer than ten years. This is so because public keys with 128 bits of security (like public keys over secp256k1 curve) can be brute-forced in less than 10 years. A party may wish to be paid to an address with security larger than 128 bits. For example, curves secp384r1 and secp521r1, have security of 192 bits and 256 bits, respectively. P2GPK UTXOs may remain unspent for arbitrary periods of time, depending on the underlying curve.
b) Default public keys: A party may hold a public key P already authenticated by a certificate authority (CA), (or P is their favourite key that they use to authenticate herself not just in the context of blockchain). Such public keys may not be compatible with secp2561k1.

Verifying a P2PK solution is fast and cheap (both in terms of fees and computing resources) due to the built-in opcode OP_CHECKSIG. On the downside, this technique yield larger scripts in exchange of increased security or compatibility.

The next two payment modalities focus on adding privacy to the spending parties.

A second application is the ability to pay to a group of public key holders. Any of the holders can spend the funds, but nobody, not even the other members of the group, will know who exactly from the group redeemed the funds. This is achieved by using an OR proof for knowledge of discrete logarithms.

A third application is a generalization to the threshold setting of the above payment modality and the standard multi-signature puzzle (P2MS): the identity of the threshold subset that is spending the funds remains unknown to anyone but to the members of the threshold subset. A combination of OR/AND proofs to bootstrap the techniques for P2GP scripts to this scenario is used and an off-chain protocol between the members to generate the nizk proof in a private manner is designed.

### 7.1 Pay to a Generic ECDSA Public Key

All elliptical curve (ECDSA) public keys are of the form PK=xG for a fixed generator G of the curve. A zero-knowledge puzzle for the knowledge of the discrete logarithm x in base G can be used instead of the standard P2PK. Here, x can be considered the signing key. Concretely, the puzzle corresponds to the proof system with knowledge set:

$$DL ( G , PK ) := \{ x ∈ {ℤ}_{p} : PK = xG \} .$$

The group homomorphism is simply φ_{DL}: [symbol] → [symbol] , φ_{DL}(x):=xG for a given generator G of the subgroup [symbol] of order p over which ECDSA is instantiated. The steps of the Prover and Verifier are detailed below.

| Σ_{φ}_{_{DL}}-Prover: | | Σ_{φ}_{_{DL}}-Verifier: | |
|---|---|---|---|
| Inputs: | | Inputs: | |
| • | Statement st := (G,PK) ∈ [symbol] | • | Statement st := (G,PK) ∈ [symbol] |
| • | Witness x ∈ [symbol] | • | Nizk proof π_{DL} := (e,z) ∈ [symbol] |
| • | Context information | • | Context information |
| | tx_dummy_sign | | tx_dummy_sign |
| Steps: | | Steps: | |
| 1. | Sample random r ∈ [symbol] | 1. | Compute A = zG − ePK |
| 2. | Compute A = rG | 2. | Compute e* = |
| 3. | Compute e = | | RO(tx_dummy_sign,st,A) ∈ [symbol] |
| | RO(tx_dummy_sign,st,A) ∈ [symbol] | 3. | If e = e* accept. Else reject. |
| 4. | Compute z = r + ex ∈ [symbol] | | |
| 5. | Output π_{DL} := (e,z) | | |

The Prover is implemented off-chain, and the context information is the dummy signature of the spending transaction. The function RO is instantiated as explained in Section 6.2.

The Verifier follows the steps of the generic algorithm template outlined in Section 5.6.2. It is implemented on-chain using e.g., the Script interface for elliptic curve arithmetic. (See also step 1 of Section 6.3.)

The resulting script is denoted as [Σ_{φDL}-verifier].

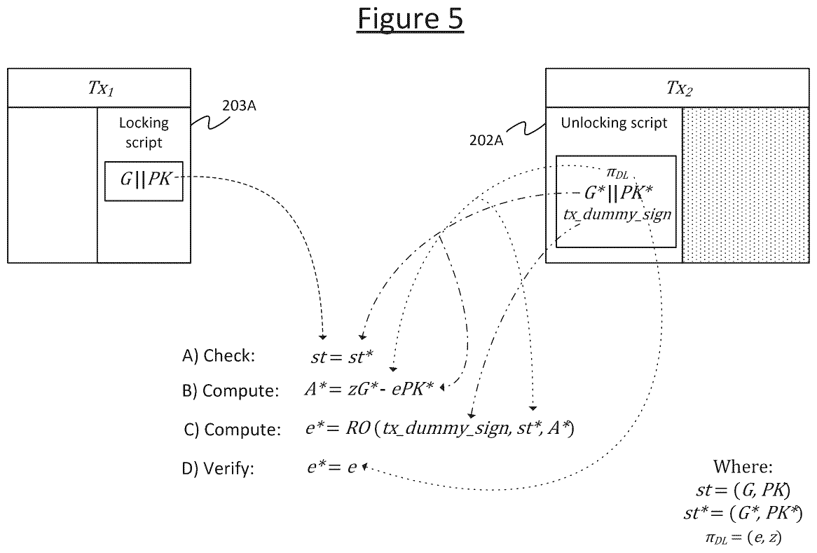

FIG. 5 illustrates the on-chain steps implemented by the verification script of a first locking script 203A of a first transaction Tx₁, referred to herein as a challenge transaction. The first locking script 203A also comprises a target statement.

A first unlocking script 202A of a second transaction Tx₂, referred to herein as a proof transaction, comprises the challenge proof π, the candidate statement, and context information portion tx_dummy_sign. These components are generated by the challenger off-chain.

At step A, the candidate statement and target statement are compared.

At step B, the candidate commitment A* is computed using the proof π=(e,z) and the candidate statement provided in the first unlocking script. The candidate commitment A* is used, along with the candidate statement and the context information portion tx_dummy_sign, to compute the candidate hash value (here the candidate challenge e*) as step C.

Finally, the candidate challenge is compared to the target challenge of the challenge at step D.

If both the candidate and target statements and the candidate and target challenges are equal, the challenger has knowledge of the proof and therefore is eligible to unlock the UTXO of the first transaction Tx₁.

### 7.1.1 Generalised P2PK Scripts

If Alice 103a wants to send, say, 1BSV to Bob's 103b public key PK∈ [symbol] , she creates a transaction with the following locking script:

$$[ Is\_P 2 GPK ] := \begin{matrix}OP\_DUP < {G}_{secp 2561 k 1} > OP\_CHECKSIGVERIFY \\ OP\_SWAP OP\_DUP < G ‖ PK > OP\_EQUALVERIFY [ {\sum }_{φ DL} - verifier ]\end{matrix}$$

G_{secp256k1} denotes the base point of curve secp256k1. The corresponding unlocking script is:

$$[ us\_P 2 GPK ] := < {π}_{DL} > < G ‖ PK > < tx\_dummy \_sign >$$

where π_{DL}:=(e,z)∈ [symbol] × [symbol] is the proof attesting to the knowledge of the signing key s, and st:=(G,PK)∈ [symbol] is the candidate statement.

### 7.1.2 Generalised P2PK Addresses

Similarly, the analogy of a P2PKH address can be considered with locking script:

$$[ ls\_P 2 GPKH ] := \begin{matrix}CP\_DUP < {G}_{secp 256 k 1} > Op\_CHECKSIGVERIFY \\ OP\_SWAP OP\_DUP OP\_HASH 160 < GPKHash > OP\_EQUALVERIFY [ {\sum }_{{φ}_{DL}} - verifier ]\end{matrix}$$

Where the address is defined as GPKHash:=RIPEMD160(SHA256 (G∥PK)). The unlocking script is exactly [us_P2GPK].

### 7.2 Pay to Group Privately

Paying to a group of public key holders can be achieved with an OR proof over the DL relation. For a given set of public keys PK₁, . . . , PKᵣ:

$$OR\_DL ( {PK}_{1} , … , {PK}_{r} , G ) := \{ x ∈ DL ( {PK}_{1} , G ) ∨ … ∨ DL ( {PK}_{r} , G ) \} .$$

All public keys are in the same group [symbol] . The steps of the OR Prover and OR Verifier are set out below.

The Prover implements the simulation set out in Section 5.3 to derive a target commitment value Aᵢ for each public key PKᵢ of the statement st for which the witness x is not the secret key. In this way, the Prover can generate a valid unlocking script with knowledge of only one private key (witness).

The Verifier then computes a set of corresponding commitment values and, based on these, computes a candidate offset value o*. The candidate offset value may also be referred to herein as a candidate hash value.

| | |
|---|---|
| Σ_{rOR-φ}_{_{DL}} - Prover: | Σ_{rOR-φ}_{_{DL}} - Verifier: |
| Inputs: | Inputs: |
| • Statement st := (G, PK₁, ... , PKᵣ) ∈ | • Statement st := (G, PK₁, ... , PKᵣ ) ∈ |
| [symbol] | [symbol] |
| • Witness: x ∈ [symbol] and index j s.t. | • Nizk proof π_{rOR-DL} := |
| PKⱼ = xG | (e₁, ... , eᵣ, Z₁, ... , Zᵣ ) ∈ [symbol] |
| • Context information | • Context information |
| tx_dummy_sign | tx_dummy_sign |
| Steps: | Steps: |
| 1. For i ≠ j do: | 1. For i = 1 ... r do: |
| a. Sample eᵢ ∈ [symbol] randomly | a. Compute Aᵢ = zᵢG - eᵢPKᵢ |
| b. Simulate proof with | $2. Compute o = RO ( {tx}_{{dummy}_{sign}} , st , {A}_{1} , … , {A}_{r} ) ∈ {ℤ}_{p}$ |
| Sim_{φ}_{_{DL}} (G, PKᵢ, eᵢ): | 3. If o = Σᵢ₌₁^{r} eᵢ mod 2¹²⁸ accept. Else |
| | reject. |
| i. Sample zᵢ ∈ [symbol] | |
| randomly | |
| ii. Aᵢ = zᵢG - eᵢPKᵢ | |
| iii. Subroutine output | |
| \hat{π}ᵢ := (Aᵢ, eᵢ, Zᵢ) | |
| 2. Sample a ∈ [symbol] randomly and | |
| compute Aᵢ = aG | |
| 3. Compute o = | |
| RO(tx_dummy_sign, st, A₁, ... , Aᵣ) | |
| 4. Compute eⱼ = o − Σ_{i≠j}eᵢ ∈ [symbol] | |
| 5. Compute zⱼ = a + eⱼx ∈ [symbol] | |
| 6. Output π_{rOR-DL} := | |
| [symbol] | |

[symbol]

indicates data missing or illegible when filed

As above, tx_dummy_sign denotes the dummy signature of the spending transaction, and the verifier is implemented on-chain in script [Σ_{rOR-φ}_{_{DL}}-verifier].

By requiring the sum of the challenges eᵢ in step 3 implemented by the Verifier to be equal the offset value, at least one of the challenges must be computed correctly, i.e. with knowledge of the secret key x. Thus, the Prover can prove sufficient knowledge of the solution to be eligible to unlock the UTXO.

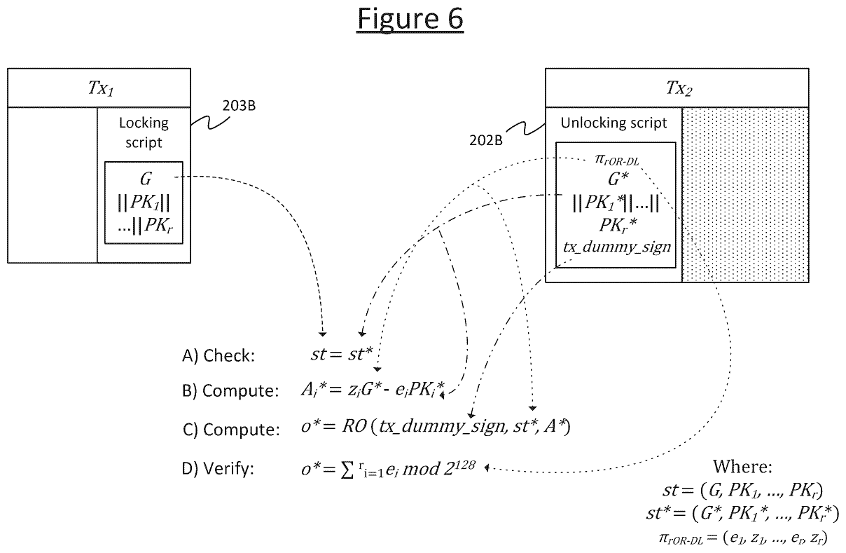

FIG. 6 illustrates the on-chain steps implemented by the verification script of a first locking script 203B of a first transaction Tx₁, referred to herein as a challenge transaction. The first locking script 203B also comprises a target statement. In this implementation, the statements comprise the public keys of each of the users.

A first unlocking script 202B of a second transaction Tx₂, referred to herein as a proof transaction, comprises the challenge proof π, the candidate statement, and context information portion tx_dummy_sign. These components are generated by the challenger off-chain. The challenge proof comprises a challenge proof portion, πᵢ corresponding to each of the keys to which the UTXO is locked, where each of the challenge proof portions comprises a corresponding challenge portion eᵢ and answer value zᵢ.

At step A, the candidate statement and target statement are compared.

At step B, the candidate commitment Aᵢ* is computed for each i=1, . . . , r using the proof π=(e₁, z₁, . . . , eᵣ, zᵣ) and the candidate statement provided in the first unlocking script. The candidate commitments Aᵢ* are used, along with the candidate statement and the context information portion tx_dummy_sign, to compute the candidate hash value (here the candidate offset o*) as step C.

Finally, the candidate offset value is compared to the sum of the target challenges over mod 2¹²⁸ at step D.

If the checks performed at steps A and D are found to be true, the challenger has knowledge of the proof and therefore is eligible to unlock the UTXO of the first transaction Tx₁.

### 7.2.1 Pay to Group Scripts

For example, to send 1BSV to the group address Alice 103a creates the locking script:

$$[ ls\_P 2 GP ] := \begin{matrix}OP\_DUP < {G}_{secp 256 k 1} > OP\_CHECKSIGVERIFY \\ OP\_SWAP OP\_DUP < G ‖ {PK}_{1} ‖ … ‖ {PK}_{r} > OP\_EQUALVERIFY [ {\sum }_{rOR - {φ}_{DL}} - verifier ]\end{matrix}$$

The unlocking script is then:

$$[ us\_P 2 GP ] := < {π}_{rOR - DL} > < G ‖ {PK}_{1} ‖ … ‖ {PK}_{r} > < tx\_dummy \_sign >$$

Where the proof is π_{OR-DL}:=(e₁, z₁ . . . , eᵣ, zᵣ)∈ [symbol] × [symbol] , and the statement is st:=(G, PK₁, . . . , PKᵣ)∈ [symbol] .

It is also possible to pay to the group address hash:

$$GPKHash := RIPEMD 160 ( SHA 256 ( G ‖ {PK}_{1} ‖ … ‖ {PK}_{r} ) ) .$$

### 7.3 Pay to Threshold Group Privately

In some instances, it is desirable to require that any subset below a threshold t of a group of public key holder can collectively redeem the UTXO without revealing which subset exactly. This is both a generalisation of the pay to group privately script (P2GP) above, and the standard multi-signature P2MS script.

For example, a 2-out-of-3 threshold, for public key holders PK₁, PK₂, PK₃, the knowledge set is:

$$\begin{matrix}THRESHOLD\_OR \_DL ( 2 , 3 , G , {PK}_{1} , {PK}_{2} , {PK}_{3} ) := \{ x , {x}^{′} ) ∈ {ℤ}_{p}^{2} : \\ x ∈ DL ( G , {PK}_{1} ) ∧ {x}^{′} ∈ DL ( G , {PK}_{2} ) \\ ∨ x ∈ DL ( G , {PK}_{1} ∧ {x}^{′} ∈ DL ( G , {PK}_{3} ) \\ ∨ x ∈ DL ( G , {PK}_{2} ) ∧ {x}^{′} ∈ DL ( G , {PK}_{3} ) \}\end{matrix}$$

The underlying AND-homomorphism is φ_{2AND_DL}: [symbol] → [symbol] , φ_{2AND_DL} ((x, x′)):=(xG,x′G). The resulting [Σ_{3OR}_{_{−2AND_DL}}-verifier] is very similar to the one outlined in Section 7.2, the only difference is that now we operate with vectors of dimension 2 over [symbol] and [symbol] .

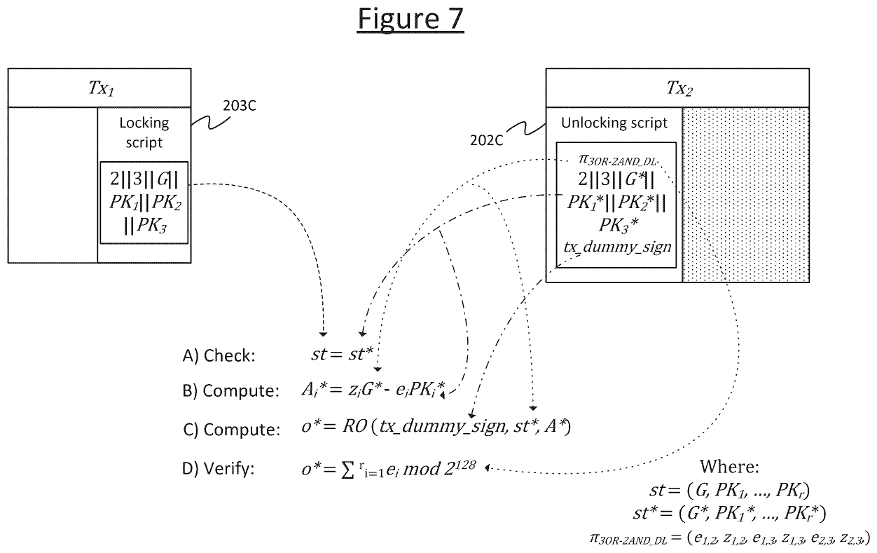

FIG. 7 illustrates the on-chain steps implemented by the verification script of a first locking script 203C of a first transaction Tx₁, referred to herein as a challenge transaction, in the case of a 2-of-3 threshold. The first locking script 203C also comprises a target statement. In this implementation, the statements comprise the public keys of each of the users.

A first unlocking script 202C of a second transaction Tx₂, referred to herein as a proof transaction, comprises the challenge proof π, the candidate statement, and context information portion tx_dummy_sign. These components are generated by the challenger off-chain. As in the example of FIG. 6, the challenge proof π comprises a challenge proof portion πᵢ corresponding to each of the keys to which the UTXO is locked.

At step A, the candidate statement and target statement are compared.

At step B, the candidate commitment Aᵢ* is computed for each i=1,2,3 using the proof π=(e_{1,2}, z_{1,2}, e_{1,3}, z_{1,3}, e_{2,3}, z_{2,3}) and the candidate statement provided in the first unlocking script. The candidate commitments Aᵢ* are used, along with the candidate statement and the context information portion tx_dummy_sign, to compute the candidate hash value (here the candidate offset value o*) as step C.

Finally, the candidate offset value is compared to the sum of the target challenges over mod 2¹²⁸ at step D.

If the checks performed at steps A and D are found to be true, the challenger has knowledge of the proof and therefore is eligible to unlock the UTXO of the first transaction Tx₁.

### 7.3.1 Pay to Threshold Group Privately Script

The locking script (for 2-out-of-3 threshold) is:

$$[ P 2 TGP ] := \begin{matrix}OP\_DUP < {G}_{secp 256 k 1} > OP\_CHECKSIGVERIFY \\ OP\_SWAP OP\_DUP < 2 ‖ 3 ‖ G ‖ {PK}_{1} ‖ {PK}_{2} ‖ {PK}_{3} > OP\_EQUALVERIFY [ {\sum }_{3 OR - {φ}_{2 AND\_DL}} - verifier ]\end{matrix}$$

The unlocking script is:

$$[ us ] := < {π}_{3 OR - 2 AND\_DL} > < 2 ‖ 3 ‖ G ‖ {PK}_{1} ‖ {PK}_{2} ‖ {PK}_{{3}^{> <}} tx\_dummy \_sign >$$

Where the proof is:

$$\begin{matrix}{π}_{3 OR - 2 AND\_DL} := ( ( {e}_{1 , 2} , {\overline{z}}_{1 , 2} := ( {z}_{1} , {z}_{2} ) ) , ( {e}_{1 , 3} , {z}_{1 , 3} := ( {z}_{3} , {z}_{4} ) ) , ( {e}_{2 , 3} , {z}_{2 , 3} := ( {z}_{5} , {z}_{6} ) ) ) ∈ \\ {( {ℤ}_{{2}^{128}} \times {ℤ}_{p}^{2} )}^{3} .\end{matrix}$$

### 7.3.2 Creating the Unlocking Script

If users (key holders) Uᵢ_{ᵢ} and Uᵢ_{₂} want to redeem the UTXO, they need to collaborate off-chain to generate the proof π_{3OR-2AND_DL}. The reason is that the witnesses for the real AND statement are the discrete logarithms x, x′ of PKᵢ_{₁} and PKᵢ_{₂} respectively. The users of the threshold subset want to keep those values privately.

For example, for a 2-out-of-3 threshold, the statement comprises three public keys belonging to three different users. Two of the three users need to collaborate to generate the proof. Each user knows their own signing key, but does not wish to share this with any other user. The protocol to create the unlocking script has three rounds.

One of the two users participating in the proof acts as a coordinator, receiving the challenges eᵢ and answers zᵢ and generating the challenge solution π_{3OR-2AND_DL} for providing in the unlocking script. In the example set out below, user Uᵢ_{₁} acts as the coordinator while user Uᵢ_{₂} provides their challenge and answer to user Uᵢ_{₁}.

The steps are:
1. User Uᵢ_{₁} start:
   a. Sample commitment Aᵢ_{₁}⁽ⁱ^{₁}^{,i}^{₂}⁾=aᵢ_{₁}G∈ [symbol] at random
   b. Send Aᵢ_{₁}⁽ⁱ^{₁}^{,i}^{₂}⁾ to user Uᵢ_{₂}
2. User Uᵢ_{₂} on input x′ received input Aᵢ_{₁}⁽ⁱ^{₁}ⁱ^{₂}⁾ do:
   a. Sample commitment Aᵢ_{₂}⁽ⁱ^{₁}ⁱ^{₂}⁾=aᵢ_{₂}G∈ [symbol] at random. Set Ā₍ᵢ_{₁}_{,i}_{₂}₎:=(Aᵢ_{₁}⁽ⁱ^{₁}ⁱ^{₂}⁾,Aᵢ_{₂}⁽ⁱ^{₁}ⁱ^{₂}⁾
   b. Sample challenges eᵢ_{₁}_{,i}_{₂},eᵢ_{₁}_{,i}_{₃}∈ [symbol] at random
   c. Simulate proofs (see Section Error! Reference source not found.):

$$\begin{matrix}{π}_{{i}_{1} , {i}_{3}} := ( {\overline{A}}_{( {i}_{1} , {i}_{3} )} := ( {A}_{{i}_{1}}^{( {i}_{1} , {i}_{3} )} {A}_{{i}_{3}}^{( {i}_{1} , {i}_{3} )} ) , {e}_{{i}_{1} , {i}_{3}} , {\overline{z}}_{{i}_{1} , {i}_{3}} := ( {z}_{1}^{( {i}_{1} , {i}_{3} )} , {z}_{2}^{( {i}_{1} , {i}_{3} )} ) ) \\ ← {Sim}_{{φ}_{2 AND\_DL}} ( G , {PK}_{{i}_{1}} , {PK}_{{i}_{3} , {e}_{{i}_{1} , {i}_{3}}} ) \\ {π}_{{i}_{2} , {i}_{3}} := ( {\overline{A}}_{( {i}_{1} , {i}_{3} )} := ( {A}_{{i}_{2}}^{( {i}_{2} , {i}_{3} )} {A}_{{i}_{3}}^{( {i}_{2} , {i}_{3} )} ) , {e}_{{i}_{2} , {i}_{3}} , {\overline{z}}_{{i}_{2} , {i}_{3}} := ( {z}_{1}^{( {i}_{1} , {i}_{3} )} , {z}_{2}^{( {i}_{1} , {i}_{3} )} ) ) ← {Sim}_{{φ}_{2 AND\_DL}} ( G , {PK}_{{i}_{1}} , {PK}_{{i}_{3} , {e}_{{i}_{1} , {i}_{3}}} )\end{matrix}$$

d. Create offset challenge:

$$\begin{matrix}o = RO ( tx\_dummy \_sign , G , {PK}_{1} , {PK}_{2} , {PK}_{3} , {\overline{A}}_{( {i}_{1} , {i}_{2} )} , {\overline{A}}_{( {i}_{1} , {i}_{3} )} , {\overline{A}}_{( {i}_{2} , {i}_{3} )} ) \\ ∈ {ℤ}_{{2}^{128}} \\ e . Compute {e}_{{i}_{1} , {i}_{2}} = ( o - {e}_{{i}_{1} , {i}_{3}} - {e}_{{i}_{2} , {i}_{3}} ) mod {2}^{128} \\ f . Create answer {z}_{{i}_{2}}^{( {i}_{1} , {i}_{2} )} = ( {a}_{{i}_{2}} + {e}_{{i}_{1} , {i}_{2}} {x}^{′} ) mod p\end{matrix}$$

g. Send Aᵢ_{₂}⁽ⁱ^{₁}ⁱ^{₂}⁾,eᵢ_{₁}ᵢ_{₂},o,zᵢ_{₂}⁽ⁱ^{₁}^{,i}^{₂}⁾,πᵢ_{₁}_{,i}_{₃} to user Uᵢ_{₁}
3. User Uᵢ_{₁} on input x,aᵢ_{₁},Aᵢ_{₁}⁽ⁱ^{₁}^{,i}^{₂}⁾ and received input Aᵢ_{₂}⁽ⁱ^{₁}ⁱ^{₂}⁾,eᵢ_{₁}ᵢ_{₂}o,zᵢ_{₁₂}⁽ⁱ^{₁}^{,i}^{₂}⁾,πᵢ_{₁}ᵢ_{₃},πᵢ_{₂}_{,i}_{₃} do:
   a. Do the following checks:
      i. Check simulated proofs πᵢ_{₁}_{,i}_{₃},πᵢ_{₂}_{,i}_{₃} verify.
      ii. Check offset is derived from the serialised transaction, statement, and commitments.
      iii. Check challenges eᵢ_{₁}_{,i}_{₂},eᵢ_{₁}_{,i}_{₃},eᵢ_{₂}_{,i}_{₃} add up to offset o (modulo 128).
      iv. Check proof (Aᵢ_{₂}⁽ⁱ^{₁}ⁱ^{₂}⁾,eᵢ_{₁}_{,i}_{₂},zᵢ_{₂}) verifies.

$$b . Compute answer {z}_{{i}_{1}}^{( {i}_{1} , {i}_{2} )} = ( {a}_{{i}_{1}} + {e}_{{i}_{1} , {i}_{2}} x ) mod p .$$

c. Create unlocking script with proof:

$${π}_{3 OR - 2 AND\_DL} := ( ( {e}_{1 , 2} , {z}_{1}^{( 1 , 2 )} , {z}_{2}^{( 1 , 2 )} ) , ( {e}_{1 , 3} , {z}_{1}^{( 1 , 3 )} , {z}_{2}^{( 1 , 3 )} ) , ( {e}_{2 , 3} , {z}_{1}^{( 2 , 3 )} , {z}_{2}^{( 2 , 3 )} ) )$$

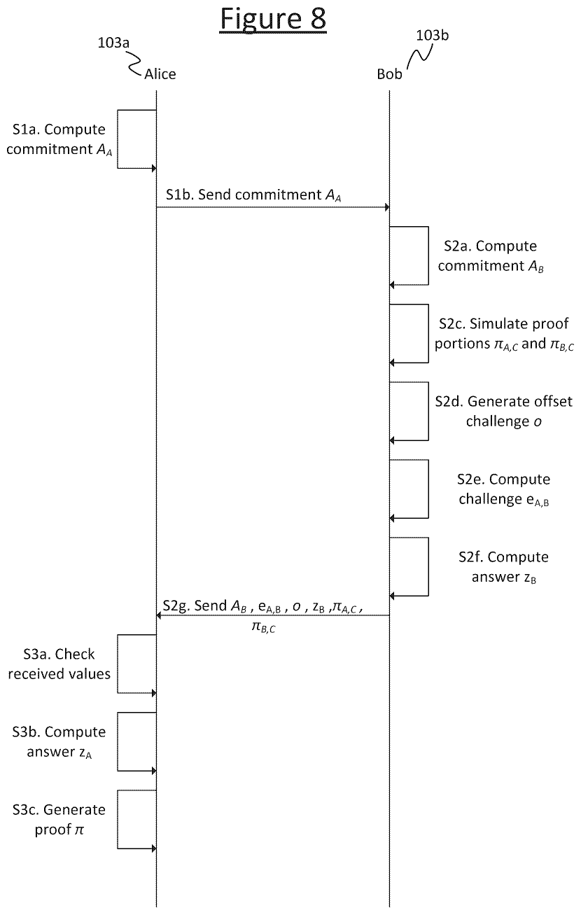

The method set our above is shown in FIG. 8. In this case, users Alice 103a, Bob 103b, and Charlie have locked funds under public keys P_{A}, P_{B}, and P_{C} respectively. Each user is able to spend with a zk-proof for the OR-AND relation. Thus, a zk-proof that attests knowledge of the 1^{st} and 2^{nd} public keys, or knowledge of the 1^{st} and 3^{rd} public keys, or knowledge of the 2^{nd} and 3^{rd} public keys can be used to unlock the UTXO of the challenge transaction.

In the example of FIG. 8, Alice 103a and Bob 103b want to unlock the UTXO. They need to generate the zk-proof that proves joint knowledge of the signing keys sk_{A} and sk_{B}. Alice 103a and Bob 103b act as the prover of the OR-AND proof, collaborating in such a way none of them reveals their private key to the other party. Herein, Alice 103a is referred to as the prover while Bob 103b is referred to as a collaborator.

The AND relation to prove knowledge of sk_{A} and sk_{B} is similar to the protocol of FIG. 4a, but in parallel: Alice 103a and Bob 103b send commitments A_{A}=aG, A_{B}=bG to the Verifier, the Verifier answers with a challenge e, and Alice 103a and Bob 103b answer with z_{A}=a+e*sk_{A} and z_{B}=a+e*sk_{B}. The same challenge e is used to generate the answers z_{A} and z_{B}, and that only Alice 103a can generate z_{A} (with the knowledge of her signing key) and only Bob 103b can generate z_{B}.

Alice 103a and Bob 103b collaborate to generate the challenge proof π in the following steps as shown in FIG. 8.

At step 1a, Alice 103a creates her target commitment A_{A} and send it to Bob 103b, step 1b.

Bob 103b then creates his own target commitment A_{B}, also referred to herein as a collaborator target commitment A_{c}, at step 2a. To generate his target commitment, Bob 103b uses his secret random value aᵢ_{₂}, also referred to as a collaborator secret randomly selected value r_{c}.

Since the signing key sk_{C} of Charlie is not known to either Alice 103a nor Bob 103b, Bob 103b simulates the proofs for knowledge of signing keys sk_{A} and sk_{C} and also the proof for knowledge of signing keys sk_{B} and sk_{C}, π_{A,C} and π_{B,C} respectively, at step 2c.

From the commitments A_{A} and A_{B}, the challenge values of the simulated proofs π_{A,C} and π_{B,C}, and the statement, Bob 103b derives the offset value o that the Verifier is supposed to issue in the interactive version of the protocol (see FIG. 4b), step 2d, and from it Bob 103b can derive the real challenge value e_{A,B}, step 2e, and his answer z_{B}, step 2e.

Bob 103b sends the simulated proofs π_{A,C} and π_{B,C}, his commitment A_{B}, the offset challenge o and the challenge value e_{A,B} to Alice at step 2g.

Alice 103a checks the values received from Bob 103b, step 3a. That is, Alice 103a checks that, among other things, the offset challenge o received from Bob 103b is derived from the transaction fields that Alice 103a is satisfied with. Alice 103a then derives her answer z_{A} using the challenge value e_{A,B}, step 3b.

Alice 103a now has all data needed to create the OR-AND proof π to be included in the unlocking script, step 3c.

This protocol is generalised to an m-out-of-n threshold as follows. Let a subset of t users [symbol] ={Uᵢ_{₁}, . . . , Uᵢ_{ₜ}}. One of the users of the set, say Uᵢ_{₁}, acts as the coordinator. It simulates the proofs and creates the offset challenge after receiving all commitments from the other users of the set. Then Uᵢ_{₁} broadcasts this information to the other users, who can check the transcript is correct, and if so, compute their answers and send them back to Uᵢ_{₁} who can create the unlocking script. Note that the size of the unlocking script is exponential in the number of users (concretely proportional to

$$( \frac{m}{n} )$$

), so it will become prohibitive with very large thresholds.

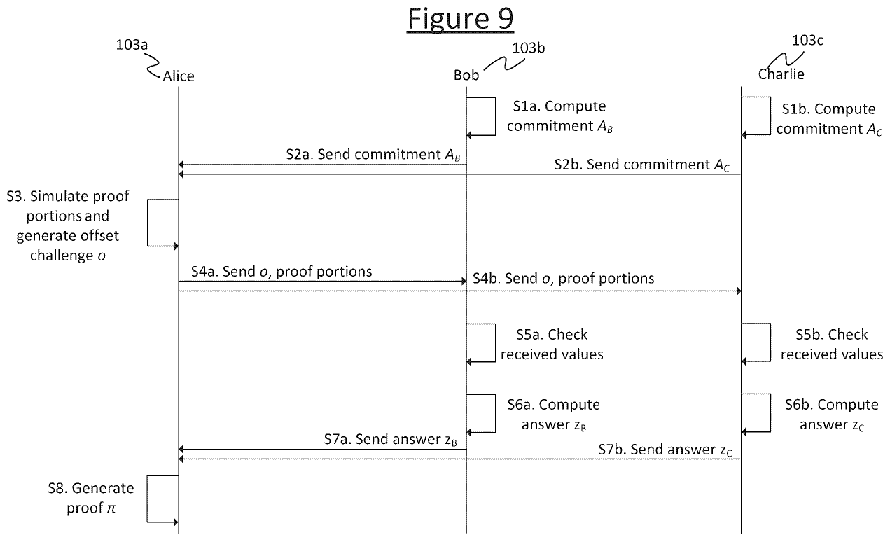

FIG. 9 illustrates the generalised protocol for a 3-out-of-n threshold, where users Alice 103a, Bob 103b, and Charlie 103c are contributing to the challenge proof. Alice 103a acts again as the coordinator, with Bob 103b and Charlie 103c acting as collaborators.

At steps 1a and 1b, Bob 103b and Charlie 103c generate compute their commitments respectively. The collaborators then send their commitments to Alice 103a, steps 2a and 2b.

Alice 103a uses the received commitments of Bob 103b and Charlie 103c, along with her own commitment, to simulate the proof portions and generate the offset challenge, step 3. Alice 103a also generates the challenge value e.

Alice 103a then broadcasts the simulated proof portions and offset challenge, steps 4a and 4b, which are then checked by Bob 103b and Charlie 103c, steps 5a and 5b. Alice 103a may also broadcast the challenge value e, however it will be appreciated that this value is fixed from the challenges of the simulated proofs and the offset challenge and therefore is not necessary.

If the collaborators are satisfied with the simulated proofs and offset value, they generate their answers, steps 6a and 6b, which are then sent to Alice 103a at steps 7a and 7b. By sending their answers z_{B} and z_{C} only after they have checked the received values, this ensures that the collaborators only provide their answers if satisfied with the transaction content. In this way, a corrupt coordinator would be unable to change the output of the spending transaction—where the funds are sent to—to something of their choice.

Once Alice 103a has received Bob and Charlie's answers, she generates the proof π for including in the spending transaction.

### 8. Alternative Embodiments

In each of the implementations set out above, the candidate statement, i.e. the statement provided in the unlocking script, is used to verify the proof. However, it will be appreciated that the target statement, i.e. the statement provided in the locking script, may instead be used when verifying the proof. This is because the target and candidate statements should be the same, which is verified in script.

In some embodiments, the unlocking script does not comprise a candidate statement. In such an embodiment, the target statement of the locking script is used to verify the proof, and the step of checking the candidate statement against the target statement (step A in each of FIGS. 5, 6, and 7) is not implemented.

It will be apricated that there is another way of verifying the proof: the direct transformation of the interactive sigma protocol into the non-interactive one. The methods set out above use “short challenge proofs”, where π=(e,z). Each of the methods described above implement the following steps:
1. Recompute the commitment A from the statement st, challenge e, and answer z (implicitly using the test equation of the verifier.)
2. Check hash (statement, commitment) matches the challenge.

As an alternative, “long challenge proofs” can be used, where the long challenge proof is defined as π=(A,e,z). The verification method comprises:
1. Execute the test equation, if it passes, then accept. The test for preimage sigma protocol is to check whether z*G=A(st^{e}).

Embodiments have primarily been described in terms of a prover and a verifier. In general, the prover and verifier may take any form, e.g. user, group of users, organisation, autonomous device, smart contract, etc. In some examples, the prover may take the form of Alice 103a, operate computer equipment 102a, and be configured to perform any of the actions described as being performed by Alice 103a with reference to FIGS. 1 and 2. Similarly, the verifier may take the form of Bob 103b, operate computer equipment 102b, and be configured to perform any of the actions described as being performed by Bob 103b with reference to FIGS. 1 and 2. The alternative may also apply, i.e. the prover may be Bob 103b and the verifier may be Alice 103a.

### 9. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.
Statement 1. A computer-implemented method for generating a challenge blockchain transaction, the method comprising:
   generating a first locking script of the challenge blockchain transaction comprising a target statement and a verification script for verifying a challenge solution π provided in a first unlocking script of a proof blockchain transaction, wherein the challenge solution π is a non-interactive zero-knowledge proof proving knowledge of a secret witness w, wherein the first locking script, when executed with the first unlocking script, is configured to:
      compute, based on the challenge solution π provided in the first locking script and one of the target statement and a candidate statement provided in the first unlocking script, a candidate commitment value A*;
      compute, using the candidate commitment value A* and one of the target statement and the candidate statement, a candidate hash value;
      verify, based on the candidate hash value, the challenge solution π; and
      verify that the challenge solution π is provided in the proof blockchain transaction; and
   causing the challenge blockchain transaction to be made available to one or more nodes of a blockchain.
Statement 2. The method of statement 1, wherein the first locking script is further configured to compare the candidate statement with the target statement.
Statement 3. The method of statement 1 or statement 2, wherein the challenge solution π comprises a target challenge value e and a target answer value z.
Statement 4. The method of and preceding statement, wherein the non-interactive zero-knowledge proof is defined by a one-way homomorphism function φ.
Statement 5. The method of statement 3 and statement 4, wherein the candidate commitment A* is defined as:

$${A}^{*} = φ ( z ) - e * φ ( w )$$

where z is the target answer value, e is the target challenge value, and w is the secret witness.
Statement 6. The method of any preceding statement, wherein the candidate statement and the target statement comprise an elliptical curve point generator G and a public key PK associate with the witness.
Statement 7. The method of statement 5 and statement 6, wherein the function φ is defined as:

φ(x)=Gx

wherein the public key is defined as:

$$PK = φ ( w ) = wG$$

wherein the candidate commitment is computed as:

$${A}^{*} = zG - ePK .$$

Statement 8. The method of any preceding statement, wherein the first locking script is further configured to verify a context information portion of the first locking script, wherein the context information portion is for proving integrity of the proof blockchain transaction.
Statement 9. The method of statement 3 or any statement dependent thereon, wherein the candidate hash value is a candidate challenge value e*, wherein the step of verifying the challenge solution π comprises comparing the candidate challenge value e* and the target challenge value e.
Statement 10. The method of statement 8 and statement 9, wherein the candidate challenge value e* is computed using the context information portion, one of the target statement and the candidate statement, and the candidate commitment A*.
Statement 11. The method of statements 3, 6, and 7, wherein the candidate statement and the target statement further comprise at least one additional public key, each public key PKᵢ being associated with a corresponding secret witness wᵢ, and wherein the challenge solution comprises a target challenge value eᵢ and a target answer value zᵢ corresponding to each witness wᵢ, wherein a respective candidate commitment A*ᵢ is computed for each witness wᵢ using:

$${A}_{i}^{*} = {z}_{i} G - {e}_{i} {PK}_{i}$$

Statement 12. The method of statement 8 and statement 11, wherein the candidate hash value is a candidate offset o*, wherein the candidate offset o* is computed using each of the respective candidate commitments A*ᵢ, one of the target statement and the candidate statement, and the context information portion.
Statement 13. The method of statement 12, wherein the step of verifying the challenge solution π comprises:
   computing a target offset o based on the target challenge values eᵢ; and
   comparing the target offset o and the candidate offset o*.
Statement 14. A computer-implemented method for generating a proof blockchain transaction, the method comprising:
   randomly selecting a secret value r;
   computing a target commitment A using the secret value r;
   computing a challenge solution π based on the target commitment A, a candidate statement, and a secret witness w, wherein the challenge solution π is a non-interactive zero-knowledge proof proving knowledge of a secret witness w;
   generating a first unlocking script of the proof blockchain transaction comprising the challenge solution π; and
   causing the proof blockchain transaction to be made available to one or more nodes of a blockchain.
Statement 15. The method of statement 14, wherein the first unlocking script further comprises the candidate statement.
Statement 16. The method of statement 14 or statement 15, wherein the challenge solution π comprises a target challenge value e and a target answer value z, wherein the target challenge value e is a hash value derived from the target commitment A and the candidate statement, and wherein the
target answer value z is computed using the target challenge value e, the secret witness w, and the secret value r.
Statement 17. The method of statement 16, wherein the first unlocking script further comprises a context information portion, wherein the target challenge value e is further derived from the context information portion.
Statement 18. The method of statement 14, wherein the candidate statement comprises an elliptical curve point generator G and a plurality of public keys PKᵢ, wherein each of the public keys PKᵢ corresponds to a secret witness wᵢ, wherein at least one secret witness wⱼ is known and at least one secret witness wᵢ is unknown, wherein the method further comprises, for each unknown secret witness wᵢ:
   randomly selecting a target challenge value eᵢ; and
   simulating a challenge solution portion πᵢ based on the target challenge value eᵢ, the elliptical curve point generator G, and the public key PKᵢ.
Statement 19. The method of statement 18, wherein the step of simulating a challenge solution portion πᵢ comprises, for each unknown secret witness wᵢ:
   randomly selecting a simulated answer zᵢ; and
   computing a simulated target commitment Aᵢ based on the target challenge value eᵢ, the elliptical curve point generator G, the simulated answer zᵢ, and the public key PKᵢ;
   wherein the challenge solution portion πᵢ comprises the simulated answer zᵢ, the simulated target commitment Aᵢ, and the target challenge value eᵢ.
Statement 20. The method of statement 19, wherein the first unlocking script further comprises a context information portion, wherein the method further comprises:
   computing a target offset o based on the challenge solution portions πᵢ corresponding to the at least one unknown secret witness wᵢ, the target commitment Aⱼ corresponding to the at least one known secret witness wⱼ, and the simulated target commitment Aᵢ, wherein the target offset o is a hash value; and
   computing a challenge solution portion πⱼ corresponding to the at least one known secret witness wⱼ based on the target offset o, the secret value r, and the known witness wⱼ;
   wherein the challenge solution π is derived from the challenge solution portions πᵢ corresponding to each secret witness wᵢ.
Statement 21. The method of statement 14, wherein the candidate statement comprises an elliptical curve point generator G and a plurality of public keys PKᵢ, wherein each of the public keys PKᵢ corresponds to a secret witness wᵢ, wherein at least one secret witness wⱼ is known and at least one secret witness wᵢ is unknown, wherein the target commitment A is a target commitment Aⱼ associated with the known secret witness wⱼ, wherein the method further comprises:
   sending the target commitment Aⱼ to a collaborator;
   receiving from the collaborator:
      at least one simulated proof portion πᵢ, each simulated proof portion πᵢ derived from a simulated target commitment Aᵢ;
      a target collaborator commitment A_{c} derived based on a collaborator secret randomly selected value r_{c};
      a target offset value o derived based on the target commitment Aⱼ, the simulated target commitment(s) Aᵢ, the collaborator target commitment A_{c}, and the plurality of public keys PKᵢ;
      a target challenge value e derived based on the target offset value o; and
      a collaborator answer value z_{c} derived based on the target challenge value e and a collaborator secret witness w_{c}; and
   compute a target answer value zⱼ based on the target challenge value e and the known secret witness wⱼ;
   wherein the challenge solution π comprises the target answer value zⱼ, the collaborator answer value z_{C}, the target challenge value e, and the at least one simulated proof portion πᵢ.
Statement 22. The method of statement 14, wherein the candidate statement comprises an elliptical curve point generator G and a plurality of public keys PKᵢ, wherein each of the public keys PKᵢ corresponds to a secret witness wᵢ, wherein at least one secret witness wⱼ is known and at least one secret witness wᵢ is unknown, wherein the target commitment A is a target commitment Aⱼ associated with the known secret witness wⱼ, wherein the method further comprises:
   receiving at least one target collaborator commitment A_{c} derived based on a collaborator secret randomly selected value r_{c}, each target collaborator commitment A_{c} generated by a respective collaborator;
   generating at least one simulated proof portion πᵢ, each simulated proof portion πᵢ derived from a simulated target commitment Aᵢ and at least one of the target commitment Aⱼ and the target collaborator commitment A_{c};
   computing a target offset value o and a target challenge value e derived based on the target commitment Aⱼ, the simulated target commitment(s) Aᵢ, the at least one collaborator target commitment A_{c}, and the plurality of public keys PKᵢ;
   transmitting to each collaborator the at least one simulated proof portion πᵢ and the target offset value o; and
   receiving from each collaborator a respective collaborator answer value z_{c} derived based on the target offset value o and a collaborator secret witness w_{c};
   wherein the challenge solution π comprises the target answer value zⱼ, the collaborator answer value(s) z_{C}, the target challenge value e, and the at least one simulated proof portion πᵢ.
Statement 23. Computer equipment comprising:
   memory comprising one or more memory units; and
   processing apparatus comprising one or more processing units, wherein the memory stores code arranged to run on the processing apparatus, the code being configured so as when on the processing apparatus to perform the method of any of statements 1 to 22.
Statement 24. A computer program embodied on computer-readable storage and configured so as, when run on one or more processors, to perform the method of any of statements 1 to 22.

1. A computer-implemented method for generating a challenge blockchain transaction, the method comprising:
generating a first locking script of the challenge blockchain transaction comprising a target statement and a verification script for verifying a challenge solution π provided in a first unlocking script of a proof blockchain transaction, wherein the challenge solution π is a non-interactive zero-knowledge proof proving knowledge of a secret witness w, wherein the first locking script, when executed with the first unlocking script, is configured to:
compute, based on the challenge solution π provided in the first locking script and one of the target statement and a candidate statement provided in the first unlocking script, a candidate commitment value A*;
compute, using the candidate commitment value A* and one of the target statement and the candidate statement, a candidate hash value;
verify, based on the candidate hash value, the challenge solution π; and
verify that the challenge solution π is provided in the proof blockchain transaction; and
causing the challenge blockchain transaction to be made available to one or more nodes of a blockchain.

2. The computer-implemented method of claim 1, wherein the first locking script is further configured to compare the candidate statement with the target statement.

3. The computer-implemented method of claim 1, wherein the challenge solution π comprises a target challenge value e and a target answer value z.

4. The computer-implemented method of claim 1, wherein the non-interactive zero-knowledge proof is defined by a one-way homomorphism function φ.

5. The computer-implemented method of claim 3, wherein the non-interactive zero-knowledge proof is defined by a one-way homomorphism function φ, wherein the candidate commitment A* is defined as:
$${A}^{*} = φ ( z ) - e * φ ( w )$$
where z is the target answer value, e is the target challenge value, and w is the secret witness.

6. The computer-implemented method of claim 1, wherein the candidate statement and the target statement comprise an elliptical curve point generator G and a public key PK associate with the witness.

7. The computer-implemented method of claim 5, wherein the candidate statement and the target statement comprise an elliptical curve point generator G and a public key PK associate with the witness, wherein the function φ is defined as:
φ(x)=Gx
wherein the public key is defined as:
$$PK = φ ( w ) = wG$$
wherein the candidate commitment is computed as:
$${A}^{*} = zG - ePK .$$

8. The computer-implemented method of claim 1, wherein the first locking script is further configured to verify a context information portion of the first locking script, wherein the context information portion is for proving integrity of the proof blockchain transaction.

9. The computer-implemented method of claim 3, wherein the candidate hash value is a candidate challenge value e*, wherein the step of verifying the challenge solution π comprises comparing the candidate challenge value e* and the target challenge value e.

10. The computer-implemented method of claim 8, wherein the candidate hash value is a candidate challenge value e*, wherein the step of verifying the challenge solution π comprises comparing the candidate challenge value e* and the target challenge value e, wherein the candidate challenge value e* is computed using the context information portion, one of the target statement and the candidate statement, and the candidate commitment A*.

11. The computer-implemented method of claim 3, wherein the non-interactive zero-knowledge proof is defined by a one-way homomorphism function φ, wherein the candidate commitment A* is defined as:
$${A}^{*} = φ ( z ) - e * φ ( w )$$
where z is the target answer value, e is the target challenge value, and w is the secret witness;
wherein the candidate statement and the target statement comprise an elliptical curve point generator G and a public key PK associate with the witness, wherein the function φ is defined as:
φ(x)=Gx
wherein the public key is defined as:
$$PK = φ ( w ) = wG$$
wherein the candidate commitment is computed as:
$${A}^{*} = zG - ePK \underline{;}$$
wherein the candidate statement and the target statement further comprise at least one additional public key, each public key PKᵢ being associated with a corresponding secret witness wᵢ, and wherein the challenge solution comprises a target challenge value eᵢ and a target answer value zᵢ corresponding to each witness wᵢ, wherein a respective candidate commitment A*ᵢ is computed for each witness wᵢ using:
$${A}_{i}^{*} = {z}_{i} G - {e}_{i} {PK}_{i}$$

12-13. (canceled)

14. A computer-implemented method for generating a proof blockchain transaction, the method comprising:
randomly selecting a secret value r;
computing a target commitment A using the secret value r;
computing a challenge solution π based on the target commitment A, a candidate statement, and a secret witness w, wherein the challenge solution π is a non-interactive zero-knowledge proof proving knowledge of a secret witness w;
generating a first unlocking script of the proof blockchain transaction comprising the challenge solution π; and
causing the proof blockchain transaction to be made available to one or more nodes of a blockchain.

15. The computer-implemented method of claim 14, wherein the first unlocking script further comprises the candidate statement.

16. The computer-implemented method of claim 14, wherein the challenge solution π comprises a target challenge value e and a target answer value z, wherein the target challenge value e is a hash value derived from the target commitment A and the candidate statement, and wherein the target answer value z is computed using the target challenge value e, the secret witness w, and the secret value r.

17. The computer-implemented method of claim 14, wherein the first unlocking script further comprises a context information portion, wherein the target challenge value e is further derived from the context information portion.

18. The computer-implemented method of claim 14, wherein the candidate statement comprises an elliptical curve point generator G and a plurality of public keys PKᵢ, wherein each of the public keys PKᵢ corresponds to a secret witness wᵢ, wherein at least one secret witness w; is known and at least one secret witness wᵢ is unknown, wherein the method further comprises, for each unknown secret witness wᵢ:
randomly selecting a target challenge value eᵢ; and
simulating a challenge solution portion πᵢ based on the target challenge value eᵢ, the elliptical curve point generator G, and the public key PKᵢ.

19. The computer-implemented method of claim 18, wherein the step of simulating a challenge solution portion πᵢ comprises, for each unknown secret witness wᵢ:
randomly selecting a simulated answer zᵢ; and
computing a simulated target commitment Aᵢ based on the target challenge value eᵢ, the elliptical curve point generator G, the simulated answer zᵢ, and the public key PKᵢ;
wherein the challenge solution portion πᵢ comprises the simulated answer zᵢ, the simulated target commitment Aᵢ, and the target challenge value eᵢ.

20. (canceled)

21. The computer-implemented method of claim 14, wherein the candidate statement comprises an elliptical curve point generator G and a plurality of public keys PKᵢ, wherein each of the public keys PKᵢ corresponds to a secret witness wᵢ, wherein at least one secret witness wⱼ is known and at least one secret witness wᵢ is unknown, wherein the target commitment A is a target commitment Aⱼ associated with the known secret witness wⱼ, wherein the method further comprises:
sending the target commitment Aⱼ to a collaborator;
receiving from the collaborator:
at least one simulated proof portion πᵢ, each simulated proof portion πᵢ derived from a simulated target commitment Aᵢ;
a target collaborator commitment A_{c} derived based on a collaborator secret randomly selected value r_{c};
a target offset value o derived based on the target commitment Aⱼ, the simulated target commitment(s) Aᵢ, the collaborator target commitment A_{c}, and the plurality of public keys PKᵢ;
a target challenge value e derived based on the target offset value o; and
a collaborator answer value z_{c} derived based on the target challenge value e and a collaborator secret witness w_{c}; and
compute a target answer value zⱼ based on the target challenge value e and the known secret witness wⱼ;
wherein the challenge solution π comprises the target answer value zⱼ, the collaborator answer value z_{C}, the target challenge value e, and the at least one simulated proof portion πᵢ.

22. The computer-implemented method of claim 14, wherein the candidate statement comprises an elliptical curve point generator G and a plurality of public keys PKᵢ, wherein each of the public keys PKᵢ corresponds to a secret witness wᵢ, wherein at least one secret witness wⱼ is known and at least one secret witness wᵢ is unknown, wherein the target commitment A is a target commitment Aⱼ associated with the known secret witness wⱼ, wherein the method further comprises:
receiving at least one target collaborator commitment A_{c} derived based on a collaborator secret randomly selected value r_{c}, each target collaborator commitment A_{c} generated by a respective collaborator;
generating at least one simulated proof portion πᵢ, each simulated proof portion πᵢ derived from a simulated target commitment Aᵢ and at least one of the target commitment Aⱼ and the target collaborator commitment A_{c};
computing a target offset value o and a target challenge value e derived based on the target commitment Aⱼ, the simulated target commitment(s) Aᵢ, the at least one collaborator target commitment A_{c}, and the plurality of public keys PKᵢ;
transmitting to each collaborator the at least one simulated proof portion πᵢ and the target offset value o; and
receiving from each collaborator a respective collaborator answer value z_{c} derived based on the target offset value o and a collaborator secret witness w_{c};
wherein the challenge solution π comprises the target answer value zⱼ, the collaborator answer value s z_{C}, the target challenge value e, and the at least one simulated proof portion πᵢ.

23. (canceled)

24. A non-transitory computer-readable medium storing computer program code that is configured so as, when run on one or more processors, the one or more processors perform a method for generating a challenge blockchain transaction including:
generating a first locking script of the challenge blockchain transaction comprising a target statement and a verification script for verifying a challenge solution π provided in a first unlocking script of a proof blockchain transaction, wherein the challenge solution π is a non-interactive zero-knowledge proof proving knowledge of a secret witness w, wherein the first locking script, when executed with the first unlocking script, is configured to:
compute, based on the challenge solution π provided in the first locking script and one of the target statement and a candidate statement provided in the first unlocking script, a candidate commitment value A*;
compute, using the candidate commitment value A* and one of the target statement and the candidate statement, a candidate hash value;
verify, based on the candidate hash value, the challenge solution π; and
verify that the challenge solution π is provided in the proof blockchain transaction; and
causing the challenge blockchain transaction to be made available to one or more nodes of a blockchain.
